(19) United States
(12) Patent Application Publication
(10) Pub. No.: US 2006/0239124 A1
(43) Pub. Date: Oct. 26, 2006

(54) Self-winding timepiece

(76) Inventor: Gregory B. Thumm, Ridgewood, NJ (US)

Correspondence Address: FISH & RICHARDSON P.C., P.O. BOX 1022, MINNEAPOLIS, MN, 55440-1022, US

(21) Appl. No.: 11/114,511

(22) Filed: Apr. 26, 2005

(51) Int. Cl. G04B 37/00; G04C 23/02

(52) U.S. Cl. 368/88; 368/206

(57) ABSTRACT

A timepiece has a case with an interior sidewall defining a cavity therein. A movement is received in the cavity and has an end surface and a side perimeter surface. The side perimeter surface is spaced inwardly from the interior sidewall of the case. A winding body is coupled to the movement about the end surface. At least a portion of the winding resides between the side perimeter surface of the movement and the interior sidewall of the case.

### BACKGROUND

The present invention relates to timepieces, and more particularly to self-winding timepieces.

A self-winding timepiece keeps time with a mechanical movement that is wound by movement of the timepiece itself. The mechanical movement is powered by energy stored in a mainspring; the mainspring stores energy as it is wound and powers the movement as it unwinds. The mainspring is wound by a winding body that shifts or moves when the timepiece is moved. In many timepieces, the winding body is configured to rotate on a winding shaft of the movement. Rotation of the winding shaft winds the mainspring.

It is desirable for the winding body to efficiently transform movement of the timepiece into winding the mainspring. The weight of the winding body, as well as the distribution of that weight, are two factors that affect the efficiency. Prior timepieces have included winding bodies sized and shaped to improve the weight and weight distribution. However, the size and shape of the winding body is limited by the space available within the timepiece.

### SUMMARY

In one aspect, a timepiece has a movement with a central axis. The timepiece includes a winding rotor coupled to the movement to rotate about an axis parallel to the central axis of the movement. The movement is configured so that rotation of the winding rotor winds the movement. A largest dimension of the movement measured perpendicular to the central axis is smaller than a largest dimension of the winding rotor measured perpendicular to the central axis.

In some instances, the movement is received in a cavity of a case, at least a portion of the winding rotor may extend into a gap between a sidewall of the movement and a sidewall of the cavity.

In some instances, the movement is received in a cavity of the case having a case back. The winding rotor is received between the movement and the case back. A dimension of the winding rotor measured parallel to the central axis is greater than a largest distance between the winding rotor and the case back measured parallel to the central axis.

In some instances, the timepiece further includes a face member adjacent the movement. The face member defines an opening about at least a portion of its parameter through which at least a portion of the winding rotor is displayed.

In one aspect, a device includes a case having an interior sidewall defining a cavity therein. A movement is received in the cavity. The movement has an end surface and a side parameter surface spaced inwardly from the interior side wall of the case. A winding body is coupled to the movement about the end surface. At least a portion of the winding body resides between the side parameter service of the movement and the interior side wall of the case.

In one aspect, a timepiece has a case with an interior sidewall defining a cavity therein. A movement is received in the cavity. The movement has an end surface and a side parameter surface spaced inwardly from the interior side wall. A winding body is coupled to the movement about the end surface and has a side surface spaced inwardly from the interior side wall the case and outwardly from the side parameter or surface of the movement.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a front view of an illustrative timepiece constructed in accordance with the invention.

FIG. 2 is a back detail view of the illustrative timepiece of FIG. 1.

FIG. 3 is a back view of the illustrative timepiece of FIG. 1 with a case back removed.

FIG. 4 is a cross sectional view of the illustrative timepiece of FIG. 1 taken along section line 4-4.

Like reference symbols in the various drawings indicate like elements.

### DETAILED DESCRIPTION

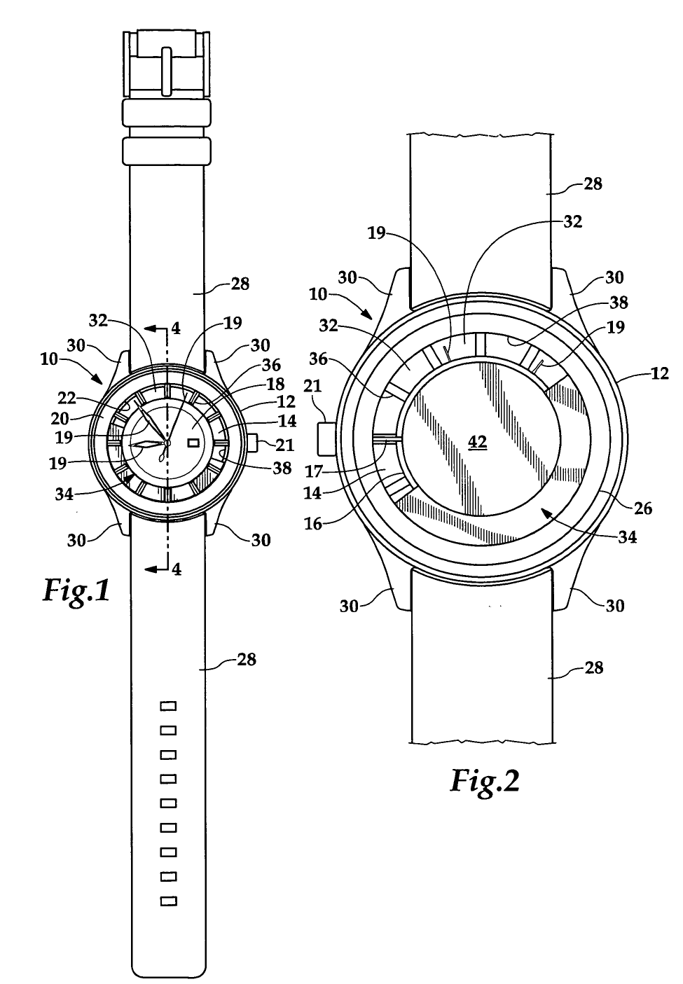

Referring first to FIGS. 1 and 2, an illustrative timepiece 10 constructed in accordance with the invention includes a case 12. The case 12 has an interior sidewall that defines a cavity 14 therein. The cavity 14 receives a movement 16 (FIG. 2) of the timepiece 10, as well as a face 18 and two or more hands 19 (three shown), therein. The face 18 resides adjacent the movement 16. A crown shaft 17 extends outward from a side of the movement 16 through a sidewall of the case 12 and is coupled to a crown 21. The case 12 may include a removable bezel 20 or the bezel 20 can alternatively be integrally formed with the case 12. The bezel 20 defines an aperture 22 through which the face 18 of the timepiece 10 can be seen. When viewed through the aperture 22, the face 18 obscures at least a portion of the movement 16.

Referring briefly to FIG. 4, the bezel 20 carries a transparent cover 24 that covers the aperture 22. The aperture 22 is depicted as being circular, but could be other shapes, for example, square, octagonal, oval, irregular shaped, or other. The transparent cover 24 is shaped appropriately to cover the aperture 22. A case back 26 is coupled to and covers the backside of the case 12. The case back 26 may include an aperture 38 through which the contents of the case 12 is displayed. As with the bezel 20, the case back 26 carries a transparent cover 40 that covers the aperture 38.

As best seen in FIG. 2, the transparent cover 40 may include an opaque portion 42 that obscures some or all of the movement 16 from view or may be wholly transparent. In FIG. 2, the opaque portion 42 is circular and has a diameter approximately the same as the diameter of the movement 16. In some instances the case back 26 may be provided without the aperture 38, and thus not display components behind the case back 26.

Referring back to FIGS. 1 and 2, the face 18 of the illustrative timepiece 10 is smaller than the aperture 22 of the bezel 20, and thus defines an opening 32 about the perimeter of the face 18. The opening 32 displays components behind the face 18, in this case a winding rotor 34. As the face 18 is circular and the aperture 22 is circular, the opening 32 is ring-shaped. Different shapes of opening 32 can be achieved by varying the relative shape of the face 18 and aperture 22. The opening 32 can be omitted by sizing the face 18 to extend at least to the inner perimeter of the aperture 22.

In a configuration having an opening 32, such as that of FIG. 1, one or more supports 36 extend radially outward from the outer perimeter of the face 18 to the case 12 to support the face 18 in relation to the case 12. The supports 36 may be opaque or transparent. For example, a single transparent disk may be provided as support 36 to support the face 18 in relation to the case 12. FIG. 1 depicts 12 equally spaced opaque supports 36 arranged to operate as indices. Fewer supports 36 may be provided and operate as indices, for example by providing four supports 36 arranged to demarcate time increments 3, 6, 9 and 12. The supports 36 however need not be arranged to operate as indices.

The timepiece 10 of FIG. 1 is configured as a wristwatch, and thus includes a strap 28 (shown in two portions) affixed at its ends to the case 12 between outwardly extending lugs 30 arranged in pairs on opposing sides of the case 12. However, the strap 28 and lugs 30 can be differently configured or omitted depending on the configuration of the timepiece 10. For example, if the timepiece 10 were configured as a pocket watch, the strap 28 and lugs 30 would be omitted. The strap 28 is operable to wrap around a wearer's wrist and to secure the timepiece 10 thereto.

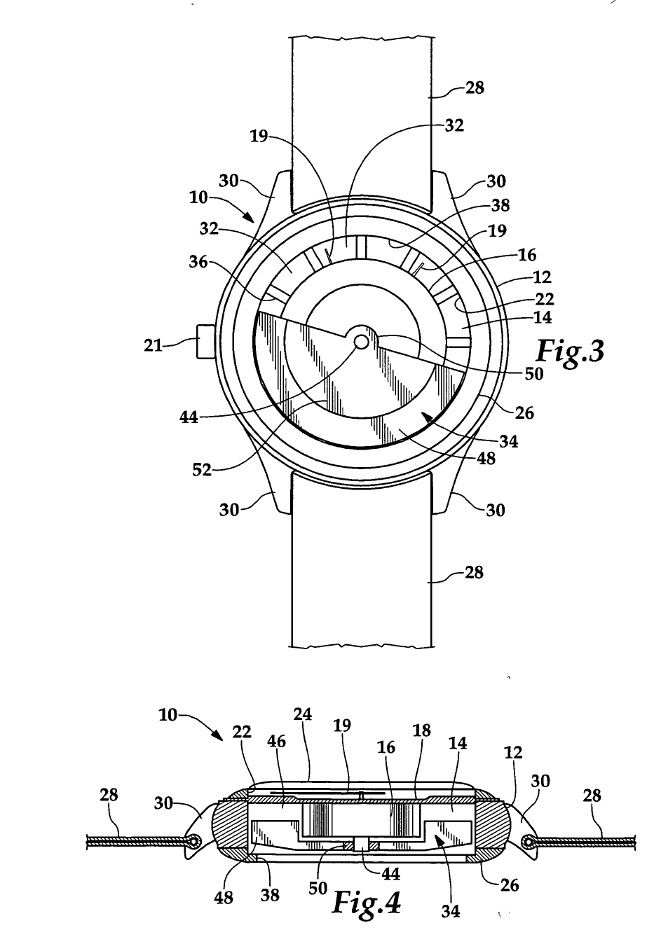

Referring now to FIG. 3, the timepiece 10 is depicted with the case back 26 removed to show the movement 16 and the winding rotor 34. The movement 16 is a mechanical type that is powered by energy stored in a mainspring (not shown). The mainspring is wound by turning a winding post 44 that protrudes outwardly from the movement 16. The winding rotor 34 is mounted to the winding post 44 so that movement of the timepiece 10 causes the winding rotor 34 to rotate in the case 12 and turn the winding post 44. Movement of the winding rotor 34 is caused both by inertial forces from the timepiece 10 being moved, as well as gravitational forces acting on the winding rotor 34 as the orientation of the timepiece 10 changes.

The movement 16 is substantially circular in profile, and is mounted to the back surface of the face 18. In conventional timepieces, the movement is typically as large as timepiece's case will allow, often the same size as the face, because larger mechanical movements are less expensive to manufacture and more accurate. In the illustrative timepiece 10 of FIG. 3, the movement 16 is substantially smaller than the case 12 can accommodate and has a slightly smaller diameter than the face 18, which itself is smaller than the case 12 can accommodate. Accordingly, a gap 46 is defined between the outer edge of the movement 16 and the interior edge of the cavity 14. The gap 46 is also seen in FIG. 4. The gap 46 corresponds approximately in width to the opening 32. In one instance, the movement 16 can be a small movement, such as for a woman's sized watch, used in a larger watch, such as a men's sized watch.

The winding rotor 34 includes an arcuate outer portion 48, a flange 50 and a web 52 that spans the outer portion 48 and the flange 50. The flange 50 is adapted to couple with the winding post 44 to mount the winding rotor 34 to the movement 16. The outer portion 48 may have a thickness (and thus weight) that is greater than the web 52, thereby increasing the mass moment of inertia of the winding rotor 34 with less of an increase in the overall weight of the winding rotor 34. In other words, the additional weight more efficiently adds to the mass moment of inertia than if it were added throughout the winding rotor 34.

As best seen in FIG. 4, the gap 46 enables the thickness of the outer portion 48 to be greater than would otherwise be possible if the winding rotor 34 was positioned entirely between the movement 16 and the case back 26 (i.e. thicker than the largest space between the movement 16 and case back 26), because the outer portion 48 may extend into the gap 46 and around the sidewalls of the movement 16. In contrast, without the gap 46 the thickness of the winding rotor 34 would be limited to the space between the movement 16 and the case back 26. Stated differently, the gap 46 enables the greatest thickness of the winding rotor 34 measured parallel to the winding post 44 to be greater than the greatest distance between the movement 16 and the case back 26.

Accordingly, both the weight and the mass moment of inertia of the winding rotor 34 can be increased over that of a winding rotor that must reside wholly between the movement 16 and case back 26 by increasing the thickness of the outer portion 48 into the gap 46. When acted upon by gravitational forces, the greater weight and corresponding greater moment of inertia of the winding rotor 34 produces more torque on the winding post and can overcome greater resistance to winding. Likewise, when moved by inertial forces, the winding rotor 34 maintains its momentum longer, better overcoming resistance to winding. In sum, the greater weight and mass moment of inertia increases the efficiency in which the winding rotor 34 winds the movement 16.

The winding rotor 34 described herein has a larger transverse dimension than the largest transverse dimension of the movement 16, so that at least a portion of the winding rotor 34 resides between a sidewall of the movement 16 and the interior sidewall of the case 12. The transverse dimension is measured perpendicular to the winding post 44. The winding rotor 34 has a larger moment arm on the winding post 44 than would a winding rotor of approximately the same size as the movement. Therefore, the winding rotor 34 exerts a greater torque on the winding post 44 as the timepiece 10 moves. In an instance where the movement 16 is a women's sized movement, the winding rotor 34 may be sized for a men's size movement. In one instance, the transverse dimension of the movement 16 is 75% or less of the transverse dimension of the winding rotor 34.

In some implementations, the winding rotor 34 or a portion thereof, such as the outer portion 48, may be formed from or configured to carry a material that is more dense than other materials of the movement 16 to increase the weight of the winding rotor 34. For example, in a movement that is made of steel, the winding rotor 34, or a portion thereof, may be formed from materials such as lead, gold or platinum. While lead has a higher density than steel, gold and platinum have an even higher density than even lead. However, gold and platinum are also substantially more expensive than lead and steel. Because the winding rotor 34 can be configured to extend into the gap 46 and around the side walls of the movement 16, more material can be provided to increase the weight of the winding rotor 34. Accordingly, a manufacturer is less reliant on the density of the material to increase the weight of the winding rotor 34, and thus can select a less dense (and less expensive) material or use less of a more dense material for the winding rotor 34 and reduce the overall cost of the timepiece 10.

In some implementations, the face 18 and/or case back 26 is configured to display the winding rotor 34. By displaying the winding rotor 34 to a potential purchaser or a person possessing the timepiece 10, the mechanical nature of the timepiece 10 is emphasized. This emphasis may improve the desirability of the timepiece 10 to entice the potential purchaser to purchase the timepiece 10. Displaying the winding rotor 34 also enables the person possessing the timepiece 10 to monitor the movement of the winding rotor 34, and ensure that the movement 16 is being wound. Because the winding rotor 34 is larger than the movement 16, the winding rotor 34 can be displayed through the front aperture 22 of the timepiece 10. Therefore, in a timepiece 10 configured as a wristwatch, the movement of the winding rotor 34 is visible while the wristwatch is being worn. In contrast, if the movement 16 is larger than or the same size as the winding rotor 34, the winding rotor 34 is obscured from view through the front aperture 22 of the timepiece 10 by the movement 16.

A number of embodiments of the invention have been described. Nevertheless, it will be understood that various modifications may be made without departing from the spirit and scope of the invention. Accordingly, other embodiments are within the scope of the following claims.

What is claimed is:

1. A timepiece comprising:
a movement having a central axis; and
a winding rotor coupled to the movement to rotate about an axis parallel to the central axis of the movement, the movement configured so that rotation of the winding rotor winds the movement and a largest dimension of the movement measured perpendicular to the central axis is smaller than a largest dimension of the winding rotor measured perpendicular to the central axis.

2. The timepiece of claim 1 further comprising a case having a cavity therein, the movement received in the cavity; and
wherein at least a portion of the winding rotor resides between a sidewall of the movement and a sidewall of the cavity.

3. The timepiece of claim 2 wherein the sidewall of the movement and the sidewall of the cavity define a gap and at least a portion of the winding rotor extends into the gap.

4. The timepiece of claim 1 further comprising a case having a case back, the movement received in the case and the winding rotor received in the case between the case back and the movement, and wherein a dimension of winding rotor measured parallel to the central axis is greater than a largest distance between the winding rotor and case back measured parallel to the central axis.

5. The timepiece of claim 1 further comprising:
a case having a bezel aperture therein, the movement and winding rotor received in the case;
a face member received by the case and obscuring at least a portion of the movement visible through the bezel aperture, the face member defining an opening about at least a portion of its perimeter through which at least a portion of the winding rotor is displayed.

6. The timepiece of claim 5 wherein the case comprises a case back, and at least a portion of the case back is transparent.

7. The timepiece of claim 1 wherein the case comprises a case back at least a portion thereof being transparent.

8. The timepiece of claim 1 wherein a largest dimension of the movement measured perpendicular to the central axis is a diameter of the movement.

9. The timepiece of claim 1 further comprising:
a case, the movement and winding rotor received in the case; and
a strap coupled to the case operable to attach the timepiece to a wearer's wrist.

10. A device comprising:
a case having an interior sidewall defining a cavity therein;
a movement received in the cavity, the movement having an end surface and a side perimeter surface, the side perimeter surface spaced inwardly from the interior sidewall of the case; and
a winding body coupled to the movement about the end surface and at least a portion of the winding body residing between the side perimeter surface of the movement and the interior sidewall of the case.

11. The device of claim 10 wherein the side perimeter surface of the movement in the interior sidewall of the case define a gap, and wherein at least a portion of the winding body extends into the gap.

12. The device of claim 10 wherein the case further comprises a case back and the winding body resides between the movement and the case back, and wherein the winding body is thicker than a largest space between the movement and the case back.

13. The device of claim 10 further comprising a face member adjacent the movement, the face member defining an opening between at least a portion of its perimeter and the interior sidewall of the case through which at least a portion of the winding body is displayed.

14. The device of claim 13 wherein the case further comprises a case back, and at least a portion of the case back is transparent.

15. The device of claim 10 further comprising a strap coupled to the case and operable to attach the timepiece to a wearer's wrist.

16. A timepiece, comprising:
a case having an interior sidewall defining a cavity therein;
a movement received in the cavity, the movement having an end surface and a side perimeter surface spaced inwardly from the interior sidewall; and
a winding body coupled to the movement about the end surface and having a side surface spaced inwardly from the interior sidewall of the case and outwardly from the side perimeter surface of the movement.

17. The timepiece of claim 16 wherein a gap is defined between the interior sidewall of the case and the side perimeter surface of the movement and wherein at least a portion of the winding body extends into the gap.

18. The timepiece of claim 16 wherein the case further comprises a case back and the winding body resides between the movement and the case back, and wherein the winding body is thicker than a largest space between the movement and the case back.

19. The timepiece of claim 16 further comprising a face member residing adjacent the movement opposite the winding body, and wherein the face member defines an opening through which at least a portion of the winding body is displayed.

20. The timepiece of claim 16 wherein the timepiece is a watch and case is sized as a man's watch and the movement is sized for a woman's watch.
